(19) United States
(12) Patent Application Publication
(10) Pub. No.: US 2007/0078696 A1
(43) Pub. Date: Apr. 5, 2007

(54) INTEGRATING HIGH LEVEL ENTERPRISE-LEVEL DECISION- MAKING INTO REAL-TIME PROCESS CONTROL

(75) Inventor: David Bonner Hardin JR., Franklin, MA (US)

Correspondence Address: LEYDIG VOIT & MAYER, LTD, TWO PRUDENTIAL PLAZA, SUITE 4900, 180 NORTH STETSON AVENUE, CHICAGO, IL, 60601-6731, US

(73) Assignee: Invensys Systems Inc., Foxboro, MA (US)

(21) Appl. No.: 11/468,683

(22) Filed: Aug. 30, 2006

Related U.S. Application Data
(60) Provisional application No. 60/712,504, filed on Aug. 30, 2005.

(51) Int. Cl. G06F 9/46

(52) U.S. Cl. 705/8

(57) ABSTRACT

An integrated production management system is disclosed for closed loop management of production requests within an enterprise. The production management system includes a business management (enterprise resource planning) system that issues production requests based upon business requirements. A production management system executes supervisory process control and manufacturing information applications providing high level control of production equipment and processes. A workflow engine, interposed between the business management system and production management system, executes event-driven logic to carry out negotiated production requests through communications with the production management system. The negotiated production requests arise from closed loop negotiations carried out between the workflow engine and business management system.

### CROSS-REFERENCE TO RELATED APPLICATION

This application claims the priority benefit of Hardin, U.S. Provisional Patent Application Ser. No. 60/712,504, filed on Aug. 30, 2005, entitled “INTEGRATING HIGH LEVEL ENTERPRISE-LEVEL DECISION-MAKING INTO REAL-TIME PROCESS CONTROL,” the contents of which are expressly incorporated herein by reference in their entirety, including any references therein.

### FIELD OF THE INVENTION

The present invention generally relates to the field of computerized enterprise decision-making and plan implementation systems. More particularly, the invention concerns carrying out high-level integration of enterprise business decisions and plans through the automated submission of instructions to a production process management system in a physical plant/production environment.

### BACKGROUND

Their exists a need for integrating factory information systems (reflecting actual plant status/production) with high level business systems such as ERP (Enterprise Resource Planning) that reflect high level enterprise decision-making (e.g., how much of a given product to produce within a specified time period). Current implementations of high-level integration exchange documents utilizing XML Schemas, such as those defined by the World Batch Forum's B2MML standard.

Manufacturing businesses are under extreme competitive pressure to minimize surplus inventory and maximize profit margins while at the same time satisfying customers' demand for product. If a customer can not purchase needed products from one company, then the customer will engage another. A primary goal of effective business management is to effectively forecast or predict the market demand for any given product and then allocate resources of a plant to meet the forecast demand. Knowing future market demand facilitates predictable planning and scheduling.

Market predictability is a function of many variables. Products in some markets are controlled by long term contracts. These markets are relatively stable and the easiest to model and predict. In other markets, the demand for products can be very volatile and fluctuate based on perturbations to any number of market variables. As the inaccuracies of long term forecasting increase and the time to build product decreases, the value of “building to order” increases. This has often been described as “on demand” or “agile” production, and requires linking the business process of order fulfillment (a component of ERP systems within an enterprise) to the manufacturing floor.

Consider a customer who desires a product such as “designer” paint and places an order with a vendor for the paint. Many questions quickly arise. Are the raw materials available? Are the people available? Is appropriate production equipment available within the timeframe specified by the customer? Which plant/site is best suited to produce the requested product? How long will it take? What special processes are needed? After selecting a site location, equipment, raw material and personnel resources, a “build order” and related instructions need to be provided to the plant. When the product has been manufactured, it is desirable to know the cost of making the product, the time required, quality control data verifying that the product meets a specification. Enterprise decision-making is also interested in what other process information was associated with the batch and how can the information be archived for later analysis and troubleshooting. Information channels must be provided to request and ultimately receive the aforementioned information. Other important enterprise information includes whether a profit was achieved during a particular transaction.

“Real time” business information processing involves making decisions with regard to customer requests and production to meet such requests within a window of time that meets customer expectations. The ability to implement real time business information processing enables an enterprise to manufacture products as needed (when needed), allows a manufacturer to reduce unnecessary production and minimize dead inventory while simultaneously satisfying the consumer's needs. Real time business information processing is thus a strong value proposition with a potentially high monetary return.

Take, for example, a case in which the time to produce a product is large, economies of scale are significant and demand can be forecast with reasonable accuracy. In this scenario, production planning and scheduling becomes very important. Planning can involve creating and solving a multivariable model which forecasts longer-term production. The long-term production plan is used as the basis for scheduling incremental production. The long-term and incremental production plans are joined in the sense that if the incremental production occurs as scheduled, then overall planned production targets are achieved. To accomplish the long-term and incremental goals, each scheduled production unit is monitored and compared with the planned or requested production unit. Any deviations are “fedback” into the plan by decision-makers so that future production runs can compensate as needed.

As illustrated above, integrating production requirements at the business level with plant-floor product manufacturing systems in an enterprise is valuable in many different product manufacturing scenarios. Traditionally integrating the business and plant/production environments has meant picking up the phone or sending an email. The importance of timeliness was downplayed in such traditional integration arrangements.

### SUMMARY OF THE INVENTION

The present invention is directed to, and generally concerns various aspects of an integrated production management system for use in an enterprise planning and manufacturing control environment. The system includes a business management system, such as an enterprise resource planning system, for providing a production request for execution by a production component of an enterprise such as a factory or plant under automated process control. The production component is controlled/managed by a production management system executing supervisory process control and manufacturing information applications providing high level control of production equipment and processes.

The system embodying the present invention also includes a workflow engine, interposed between and communicatively coupled to the business management system and production management system. The workflow engine executes event-driven logic to carry out a negotiated production request through communications with the production management system. The negotiated production request is based upon the production request received from the business management system, and the negotiated production request arises from closed loop negotiations carried out between the workflow engine and the business management system.

The present invention is also directed to a workflow engine embodying the aforementioned functionality as well as a method carried out by such a system and a computer readable medium including computer executable instructions for performing the method.

### BRIEF DESCRIPTION OF THE DRAWINGS

While the appended claims set forth the features of the present invention with particularity, the invention, together with its objects and advantages, may be best understood from the following detailed description taken in conjunction with the accompanying drawings of which:

FIG. 1 is a schematic diagram depicting an exemplary arrangement of functional components of an enterprise including a production request source, an automated production process/plant, and a workflow engine interposed between the production request source and the production process/plant to facilitate integrated automated fulfillment of production requests from business units of an enterprise; and

FIG. 2 is a flowchart summarizing a set of steps performed by a system of the type depicted in FIG. 1 to issue, negotiate, and fulfill a production request.

### DETAILED DESCRIPTION OF THE DRAWINGS

As a company's processes and systems are modernized, tangible economic benefits can be obtained through tighter integration of business and automation systems. Such tighter integration is provided in a system described herein where a computer-instruction driven workflow engine interposed between a source of production requirements (e.g., an ERP system) and automated plant/production equipment.

A workflow engine is described herein, incorporating a set of presently available technologies, that facilitates integrating factory floor control systems in real time to such business systems. At the factory control level, messaging technologies include OPC-DA, real time messaging buses, and transactional message buses. Messaging technologies used at the plant-wide level for integration of the factory floor with information systems include OPC-XML, IBM MQSeries and Microsoft BizTalk Orchestration. These are linked to ERP systems via standardized message exchange adapters. Standardized Service Oriented Architectures (SOA) further enable multi-vendor interoperability. By applying these technologies, businesses can realize significant improvements in asset and resource management and agility in responding to changing market conditions. Additionally these technologies provide minute-to-minute visibility into key performance indicators (KPI) leading to greater profitability.

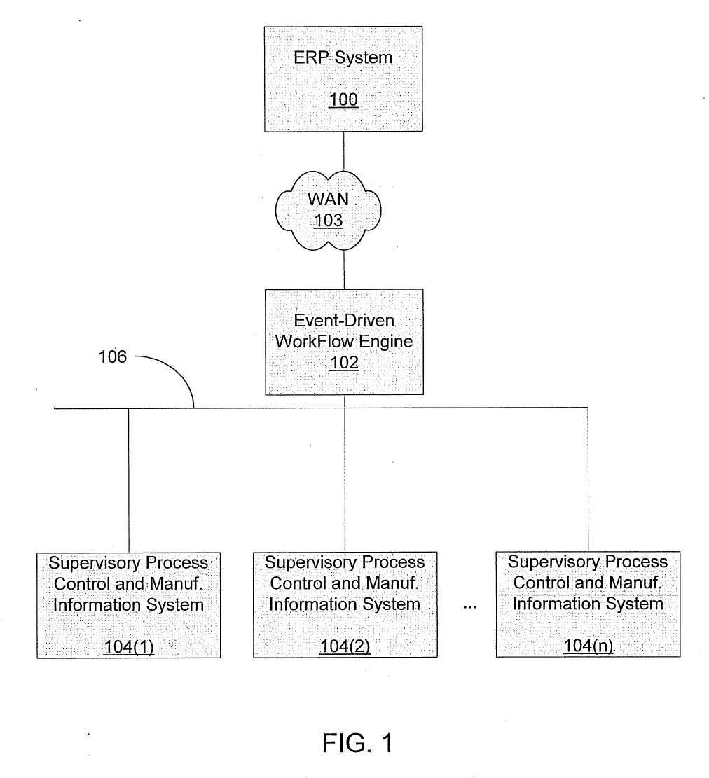

Turning to FIG. 1, an exemplary high-level drawing summarizes the relationships between the primary functional components of a system embodying the present invention. An ERP system 100 operates as a source of production requests for a plant/production facility. Such requests are submitted, by way of example, via standard S95 XML messaging over a secure WAN link 103 (e.g., the Internet, a corporate intranet, etc.).

An event-driven workflow engine 102 receives the production requests from the ERP system 101 via the link 103. The event-driven workflow engine 102 operates as an intermediate integration layer between the ERP system 100 and plant level automation processes to negotiate, actively coordinate and manage execution of the production requests. The workflow engine 102 maintains a table of available production resources (raw materials, process equipment, production line available throughput, etc.). As a production request is fulfilled, the event-driven workflow engine 102 maintains current production state. Furthermore, the workflow engine 102 also maintains an auditable history of intermediate production status events that drive/defme/memorialize the workflow engine's production logic/states. Sequential and/or state machine logic incorporated into the event-driven workflow engine 102 processes the received production requests issued by the ERP system 100.

As a result of such processing, the workflow engine 102 passes high level commands/instructions to one or more communicatively coupled supervisory process control and manufacturing information systems 104(1)-104(n) that carry out high level control of a plant/process to render products fulfilling the production requests issued by the ERP system 100. An example of such systems is described, for example, in Resnick et al., U.S. patent application Ser. No. 10/179,668 (Pub. App. US 2002/0198920). However, the types of systems 104 are not limited to the aforementioned example.

The workflow engine 102 resides, by way of example, on an application computer (with or without a human-machine interface) residing on a production/plant information network 106. The workflow engine 102 communicates with the supervisory process control and manufacturing information systems 104(1)-104(n) via the production/plant information network 106. The communications are carried out using either open or proprietary messaging (e.g., OPC-DA, OPC-UA, etc.) in combination with lower level network communications protocols such as TCP/IP or HTTP. The workflow engine 102 transmits, for example, process set points and dynamic configuration data to the systems 104(1)-104(n). The workflow engine 102 receives runtime process data from the systems 104(1)-104(n) including: alarms, events, historical data, and configuration data.

Importantly, the ERP system 100, workflow engine 102 and the systems 104(1)-104(n) operate in substantially real time to respond/adapt to changing factors influencing both the business and production aspects of a production plan request. For example, if a cost of a raw material for fulfilling a request temporarily spikes, the workflow engine 102 may temporarily suspend completion of a pending production request until the cost of the raw material falls (assuming the completion of the task can be delayed). In other instances, the workflow engine 102 reallocates plant resources to respond to an actual/forecast increase in demand for a particular product. The workflow engine 102 thus operates as an automated liaison between business systems and production systems that automatically takes into consideration the requests and status of both systems to achieve effective coordination/accommodation of business needs and production facility capabilities/costs.

One or more of the systems 104(1)-104(n) process the commands/instructions to carry out the production requests originally issued by the ERP system 100 and to render requested products. The systems 104(1)-104(n) are, in turn, communicatively coupled to any of a variety of currently known and later developed types of physical plant control equipment (e.g., distributed control systems, control processors, programmable logic controllers (PLCs) that carry out control and convey completion of actual production requests in a physical plant.

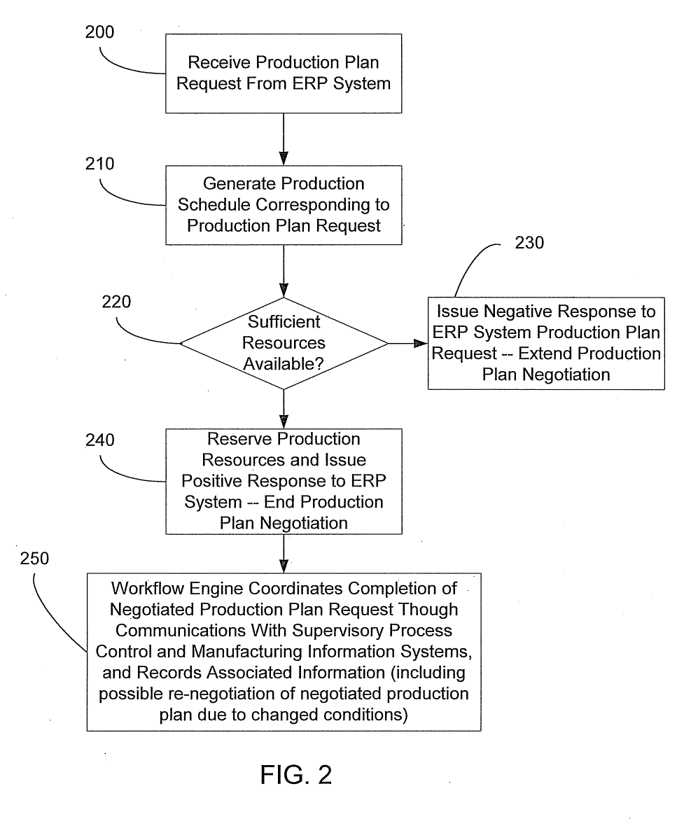

Having described primary functional components of an exemplary production system, attention is directed to a set of steps depicted in FIG. 2 summarizing an exemplary process flow carried out by the system depicted in FIG. 1 to process a production request issued by the ERP system 100. Importantly, in contrast to enterprise production decision-making wherein the ERP system dictates non-negotiated production requests to a production management system, in exemplary embodiments, production request decision-making is distributed between the ERP system 100 and the workflow engine 102. Furthermore, a negotiation process is introduced wherein an initial request from the ERP system 100 can initially be rejected by the workflow engine 102. Thereafter, the ERP system 100 and workflow engine 102 engage in further request/response negotiated decision-making to render an acceptable production request that is thereafter fulfilled through communications between the workflow engine 102 and the systems 104(1)-104(n).

In an exemplary embodiment, during step 200 the workflow engine 102 receives a production plan request (e.g., 1000 units of chemical X by time T), issued from the ERP system 100, to be fulfilled by a physical plant (or plants) within an enterprise. A production plan request generally includes more than just a request for a particular amount of some identified item. The plan request often includes a time frame within which the production needs to be complete. The form/protocol of the production request (e.g., conforming to S95) varies in accordance with various embodiments of the system described herein. In addition to a quantity and a time, exemplary parameters specified in the production requests may include raw materials required, product quality tests/requirements, plant equipment resources required, personnel resources required, product specifications, process capabilities required, etc. The specific type and quantity of information delivered from the ERP system 100 to the workflow engine 102 via the network link 103 may vary depending upon the information state that is maintained by both the ERP system 100 and the workflow engine 102.

The information type and quantity also depends upon the active decision-making capabilities/authority of both the ERP system 100 and workflow engine 102. In exemplary embodiments, production requests are formed according to a negotiated decision-making process carried out by the ERP system 100 and the workflow engine 102. In the illustrative embodiment, decision-making is distributed between the ERP system 100 which submits production requests and the workflow engine 102 which applies knowledge of production resources to the production requests prior to authorizing the request. The ultimate authority over authorization of production requests varies in accordance with alternative embodiments of the invention. However, regardless of where decision-making authority ultimately lies, in accordance with illustrative embodiments, the decision-making process is distributed to at least some degree between the ERP system 100 and workflow engine 102.

In accordance with exemplary embodiments, production requests are negotiated between the ERP system 100 and the workflow engine 102. Thus, in response to receiving an initial production plan request (e.g., 100 units by time T), during step 210 the workflow engine 102 calculates a production schedule to be implemented by physical plant resources under automated direction/monitoring provided by the supervisory process control and manufacturing information systems 104(1)-104(n) and communicatively coupled plant controllers (e.g. control processors, PLCs, etc.). The production schedule specifies production resources needed (e.g., personnel, equipment, raw materials, etc.). The production schedule also includes a specification of processes and products required to fulfill the production request. In the case of ISA S95 standard protocols, the process and product requirements are specified in the form of Process Segment/Process Capability/Production Definition expressions.

Next, at step 220, if the production request received from the ER-P system 100 cannot be fulfilled, then control passes to step 230 wherein the event-driven workflow engine 102 issues a negative response to the ERP system 100. The negative response identifies the request and, optionally a reason why the request cannot be fulfilled at the present time and a counter-offer for a production request that can be fulfilled (e.g., a reduced amount if insufficient raw materials, an extended time period if throughput is insufficient). In the exemplary embodiment, it is up to the ERP system 100 to re-submit a revised request (via step 200 described above) upon receiving a negative response from the workflow engine 102. Conforming the production request to production resources/constraints is a negotiation process between the ERP system 100 and the workflow engine 102. In accordance with exemplary embodiments, the negotiation process is expedited through automated closed loop operations performed in concert by the ERP system 100 and the workflow engine 102 through the use of rule-based inferences (or other defined automated decision-making modes) based upon production resource cost/availability data managed by the workflow engine 102.

On the other hand, if the workflow engine 102 determines that indeed the production request can be fulfilled, then control passes from step 220 to step 240. During step 240 the workflow engine 102 allocates/sets aside production resources needed to fulfill the negotiated production plan request. For example, the workflow engine 102 reserves plant production lines for a specified amount of time, claims a quantity of material/product produced from a process/production line, and/or reserves specified quantities of raw materials that are expected to be needed to fulfill the current request. The workflow engine also issues a positive response to the ERP system 100 indicating that the production request has been accepted and will be processed.

Thereafter, during step 250, the workflow engine 102 communicates with one or more of the supervisory process control and manufacturing information systems 104(1)-104(n) to complete the negotiated/accepted production request. As noted above, during the execution of the production request, the workflow engine 102 issues commands/instructions to the supervisory process control and management information systems 104(1)-104(n) specifying process set points and dynamic configuration data. The systems 104(1)-104(n) transmit runtime process data including alarms, events, historical data, and configuration data that memorialize, in an incremental/auditable manner, fulfillment of the production plan request. Thus, when a request has been completely fulfilled, a production performance record is created by the workflow engine 102 that specifies, for example, equipment used, material/equipment/personnel resources consumed, and process/production data (e.g., batch/serial numbers). Furthermore, during the completion of a production request, the workflow engine 106 maintains communications with the ERP system 100 to receive and adapt completion of the production request (re-negotiate a pending production request) according to changing conditions affecting the enterprise including, by way of example, business variables (e.g., supply costs, increased demand, etc.), concurrently pending production requests, and changes to production capabilities affecting production capacity, etc.

Taking a closer look at how the above-described system and method are carried out, one particular enabling technology is the ISA S95 standard. The S95 standard specifies data types/structures particularly useful for production management and communicating information between business and production systems. S95 consists of an abstract object model with associated attributes. The following statements are excerpted from ANSI/ISA-95.00.01-2000 putting into perspective the goals of the standard with respect to real time production systems:

Annex C (Informative)—Discussion on Models
“. . . the trend in systems integration has been toward the use of automatic control in its broadest sense (including dynamic control, scheduling and the closure of information loops) to integrate all aspects of the plant's operations including closing the information loops within the plant . . . . It has long been known which tasks such a system had to be able to carry out to accomplish these goals. Only since the advent of advanced computer technology has it been possible to handle the enormous computational load involved in carrying out these functions in real time and thus hoping to compensate for all of the factors affecting plant productivity and economic return.”

Table D-II—An Overall Plant Automation System Must Provide
“4—A method of assuring the overall reliability and availability of the total control system through fault detection, fault tolerance, redundancy, uninterruptible power supplies, maintenance planning, and other applicable techniques built into the system's specification and operation.”

The reference in Annex C to “real time” does not restrict the concept to traditional data acquisition, control and actuation loops. Ideally the manufacturing component of an enterprise has all of its information loops executing with minimum lag times and has optimal information density with proper context in addition to a well-defined feedback mechanism.

The reference in Table D-II to “reliability and availability of the total control system” should not be interpreted narrowly, nor should it be considered to be the responsibility of an external system. The “total control system” includes information loops. In exemplary embodiments, reliability and availability are in fact system parameters measured in real time and used to guide decision-making by the workflow engine 102. Traditional off-line maintenance management systems (MMS) do not deal with information about plant resources in real time. The S95 Standard acknowledges that any existing external MMS needs to be integrated and includes model components accordingly. However there is a great business benefit to be gained by implementing features of the maintenance management model using real time messaging technologies and by integrating with the personnel and equipment models by direct relationship modeling. Such integration is achieved by the workflow engine 106 using the functional model depicted in FIG. 1 described herein above.

The flexibility of the S95 models with respect to varying industry requirements is illustrated by an example cited in ANSI/ISA-95.00.02-2001:

B.3 Multiple Products Per Process Segment
“. . . In petrochemical refining and chemical production it is even more complicated, since the ratio of produced material can vary based on production parameters (such as temperatures of trays in distillation columns) and on the specific properties of the consumed materials (such as the sulfur content of the oil). In those cases, if the information needed to be exchanged on a regular basis, the most common approach would be to extend the Process Segment-Material Segment Specifications to include the mathematical relationships, such as an equation, tables, or LP, or a reference to an LP, equation, or table.”
   The information exchange regarding products produced in process segments carries context so that segment response information is interpreted immediately, either by operators, or by automated optimization technologies such as Advanced Process Control (APC) or workflow orchestration technologies such as BizTalk incorporated into the workflow engine 106. The example cited in S95 B.3 above is implemented, for example, by encapsulating, and running on the workflow engine 106, the referenced mathematical relationships as executable code and serializing them using XML-encoded SOAP (Standard Object Access Protocol) transmission protocol. A specific code module is specified for a particular process segment and for a particular product. Upon initiating a production run, production management tools ‘inject’ the code module into the APC controller incorporated within the workflow engine 106. The tools handling the segment response carry a reference to the code module (or even the serialized code module itself) as context for analysis of the production results.
   Key Performance Indicators (KPI)—Moving from Process State to Business State

The concept of “information loop”, introduced above, is an important one. It is similar to closed-loop feedback control in process automation where process variables are monitored and process actuators are controlled in “real time” in such a way as to minimize the difference between the desired condition and the actual condition. In an information loop, the variables measured are often called “Key Performance Indicators” (KPI). KPI variables measure industry-specific business level properties that can vary with time and that reflect a business state. In addition, the feedback control mechanisms and the actuated outputs of information loops differ substantially from their simple single control loop counterparts in distributed control systems. Notably, information loops are generally complex with many interdependent variables. The variables are monitored and visualized within an enterprise. To further quantify this, what's measured must be available and seen within a time frame that allows 1) actions to be taken that can affect the immediate outcome or 2) actions to be taken that effect subsequent manufacturing cycles. If these aren't met, then the information is useful for historical analysis or accounting purposes only. Scenario one implies a fast response and is normally associated with closed loop control. Scenario two is a slower process but is still a closed loop process.

Another concept that affects KPI variables is that the levels of abstraction change as information flows vertically up an organization. Using a continuous petrochemical process as an example, at the control level, the physical attributes of a process such as flows, pressures and temperatures are of importance. These variables are directly measured and controlled by a distributed control system within a plant. At the process and advanced control level, the flow of a liquid in a pipe becomes the number of moles of a specific chemical flowing in the pipe. The generic liquid becomes a specific chemical. At the yield accounting and ERP level, the unit of granularity is typically the total chemical flow into and out of a process unit or area during some time period. At the highest business level, the total quantity and quality of a valuable chemical product produced by a plant, within some time period, along with the total resources required to produce that amount of product, are of primary importance. Key variables exist at each of these abstraction levels.

Types of information loops within manufacturing include both production operations and asset maintenance. Comprehensive resource management requires both. Often in the past, these two areas were treated as essentially orthogonal areas which were loosely coupled. The separation of the two areas was reinforced by organizational structures that mated them together at the highest levels of authority. The indigenous relationship and interdependencies that exist between operations and maintenance are becoming more and more recognized as is the importance of preventative maintenance and model-predictive asset management.

Tactical Integration Technologies for S95

“Time is of the Essence”

Integrating business and production/plant management is a non-trivial task. In the illustrative embodiment, the workflow engine 102 incorporates integration technologies that operate at cyclical rates appropriate for a managed process—including integrated/coordinated decision-making implemented in substantially real time. For example, although distillation in a refinery can't be redirected to make different cuts from one minute to the next, it is possible to plan for two or more changes in cuts over the course of a day, directing product streams to different post-distillation processing units at the scheduled hour, or simply directing the streams to different storage vessels.

In discrete manufacturing, a work cell assembling customized computers is an example of the rapid reallocation of resources. Each computer has a unique specification which includes both the hardware and software components that must be installed. The time cycle of the work cell can be defmed in minutes and there could be dozens of different orders flowing through that work cell in a given day.

Physical processes comprise numerous measurable components which may or may not include sensors and transmitters and data acquisition. In the design of the process, whether continuous or discrete, an engineer makes decisions about what should be measured and what should be controlled. Computer technology in general has expanded the limits with regards to what measurements can be acquired and which actuation elements can be manipulated to control a process. The evolution of computer technologies for information sharing in real time has expanded the limits with regards to how much influence business processes can have on the control of physical processes. In the illustrative embodiment, the workflow engine 102 exploits current communications capabilities of business systems and supervisory process control and manufacturing information systems to achieve integrated/coordinated decision-making and management of an enterprise.

Successful information integration requires three core components: structured data content, standard data delivery, and business process workflow. Each of the three core components are discussed below.

Structuring Data Content

The nature of data in documents has changed dramatically with the introduction of XML as a standard. But XML alone is insufficient. It is simply a formatting specification which is “human readable” and can be verified as “well formed”. The creation of XML Schemas has accelerated the adoption of XML into many document-centric information systems by providing rich metadata that can be used for document validation. Furthermore, computer database vendors have formally embraced XML documents as native data types that may be stored directly into a database. They also embrace schemas as standard technology for defining database structure and provide powerful XML-based query protocols based upon XPath and XQuery specifications.

Enterprise system integration of data content has been significantly improved by removing the ‘proprietary’ nature of the document format. An XML Schema specifies both format and allowable content as well as allowable names for tagged information. Vertical market industries have collaborated to specify XML Schemas that provide structure to the documents that are exchanged between entities of the enterprises serving those vertical markets. An example is the Rosetta Schema used for coordinating information in purchase orders for parts in the electronics industry.

The ISA S95 standard recommends a common model and data structure for information exchange between enterprise business systems and process systems that make products specified by the business systems. This model is an abstract model which can be realized in many different forms. The World Batch Forum (WBF) has developed the B2MML (Business to Manufacturing Markup Language) standard for batch/discrete manufacturing processes which represents a concrete XML Schema implementation of a subset of S95. In addition, ISA has created the S88 abstract batch standard for modeling batch processes with the WBF providing the BatchML (Batch Markup Language) XML Schema. Data content structured according to common industry and enterprise specifications is important, but not sufficient, for successful integration because the documents must be transported between systems.

Standardizing Data Delivery

The issue of standard data delivery has been around for quite a long time. Many control system engineers never experienced the paradigm shift that occurred moving from a large variety of different vendor-specific electrical and pneumatic signal transmission encoding schemes to the three primary standards defmed by ISA—i.e. 4 to 20 mA, 1 to 5 volts, and 3 to 15 psig. The engineer's decision was greatly simplified to one of three choices: “current”, “voltage” or “pneumatic pressure”. Transmitters and receivers could be purchased accordingly. Transmitted signals could be easily decoded by standard receiving equipment (electronic or pneumatic indicators, loop controllers or chart recorders). The control engineer's work focused on managing loop sheets and instrument lists. There is however a significant limitation imposed by traditional control systems—the information transferred has very simple content and is hardwired point-to-point. A different data transfer technology is needed to encode and deliver S95/B2MML documents between enterprise and manufacturing systems.

Data delivery today is done almost universally using TCP/IP (or UDP/IP) transport over Ethernet. But TCP/IP by itself doesn't specify the encoded information. It is simply a standard transport protocol for an Ethernet network. In order to successfully transmit information content, an application-level protocol is required. There are many high-level protocols in use today that provide a rich variety of features and capabilities. HTTP (Hyper Text Transfer Protocol) specifies a protocol that supports on-the-fly message encapsulation and translation and is widely used on the Internet. This is very important for messaging systems as it enables the ability to dynamically change message destinations.

In addition to translation and encapsulation, real time messaging software incorporated into the business system and production system interfaces of the workflow engine 102 possess the following basic characteristics:
Low latency and high throughput
Event-driven/report-by-exception semantics
Fast failure detection
Failover to a backup channel upon failure detection and
Indigenous security

Given the volume of network traffic and the propensity for interruptions in network services, a transaction queuing system is incorporated into the network interfaces of the workflow engine 102 and associated communications partners such as the ERP system 100 and supervisory control systems 104(l)-104(n). Several vendors provide technology that supports guaranteed, secure message delivery. These transaction-based messaging systems are typically referred to as “Messaging Buses”. Examples are BEA, TIBCO, IBM's MQSeries and Microsoft's MSMQ. Transactions are critical for ensuring data integrity and correctness through adherence to the ACID principles: Atomic, Consistent, Isolated and Durable.

Message transactions come at a price: response time. Transferring S95/B2MML documents can take valuable application processing time. Sufficient system bandwidth is essential for the real time operation of business rules applied to feedback control mechanisms in manufacturing processes.

Message buses also provide asynchronous queuing for messages. This effectively decouples the processing of a series of interconnected applications and allows each to be optimized individually. Throughput and scalability is often increased at the expense of individual transaction response.

Enterprise Service Bus (ESB) vendors promise a robust architecture for integrating enterprise systems of all types. This technology implements a very good general concept, but lacks an industry-accepted definition.

The lack of interoperability between vendors' applications significantly increases the cost of integration. The ability to utilize and leverage best-of-breed applications from several vendors allows customers to negotiate functionality in a competitive environment without sacrificing overall system functionality. Two industry standards currently exist for implementing information exchange within manufacturing systems: OPC-DA and OPC-XML. OPC-DA is excellent for interoperable transport of simple data using Microsoft's COM. It provides a partial solution to integration of business and production systems and it can be used to tunnel XML documents through its string data type. OPC-XML is excellent for transporting simple data using Web Services. In addition, it has been utilized to tunnel S95/B2MML documents using the “string” datatype. Both of these protocol standards are primarily focused on providing message delivery within S95 Level 3 production systems. In order to successfully bridge the functional gap between Level 3 systems and Level 4 Enterprise systems, as defined in S95, it is necessary to look at technologies for handling workflow and complex transactions.

Integrating Business Process Workflow

The concept of business process workflow has long been a particularly gray area for integration projects connecting real time manufacturing with ERP systems. Point-to-point technologies were essentially the only way to implement data exchange, and the handling of workflow was dictated by the way that endpoints were attached and by how the messages were formatted for each individual point-to-point connection. Microsoft Corporation has launched a bundle of technologies called the “Value Chain Initiative” that attempt to address the complexity of the problem. With the advent of Microsoft Corporation's NET Framework and the associated Visual Studio .NET development suite the “Value Chain Initiative” became Microsoft “BizTalk”.

In an exemplary embodiment, the workflow engine 102 incorporates the functionality of Microsoft's BizTalk or similar technology. The suite of technologies integrated into BizTalk result in applications that are resilient to communication interface changes. BizTalk supports multiple message transport standards including a SOAP-based (Standard Object Access Protocol) Web Services stack. BizTalk's architecture assumes that message content format mapping is resolved by the system using source/target parameters. The architecture accommodates the fact that messages may not be XML encoded at both ends. Also within the BizTalk architecture, there is an infrastructure for managing security through the support of standards such as HTTPS and Kerberos.

BizTalk avoids point-to-point integration complexity by routing messages using standard integration services. Although custom interfaces may be required, numerous adapters are available that provide connection services for many applications, including well-known ERP systems. Example adapters: are FTP, HTTP and HTTPS, MSMQ, SQL, EDI, SMTP, Files, MQSeries, Web Services with WS-Security and WS-Policy. Specific adapters for SAP are available for IDOC, BAPI, and now XI.

The BizTalk architecture supports design and implementation of business processes, state management, and transaction management. Both short and long running transactions are accommodated via the asynchronous design and by publish-subscribe message buses. For ERP system integration, real time is relative. Short running transactions may be a matter of minutes. Long running transactions may transpire over hours. The BizTalk architecture also supports the flexible implementation of business rules and policies.

The developer toolset for BizTalk is integrated with Visual Studio .NET including plug-in designers for message schema, message maps, business processes (called Orchestrations), business rules and policies. Additionally, the system has a set of management tools and a simplified deployment methodology, implemented using .NET assemblies and manifests.

A structural analysis of the components of the BizTalk architecture reveals the following major components: Rules Engine, several modules addressing Orchestration and Integration Services. Integration Services encompass: Topology, Publish-Subscribe, Management, Tracking, Security Adapters, Message Format and Message Transformation.

Several key aspects of an integrated system, such as the one facilitated by the workflow engine 102 described herein above with reference to FIGS. 1 and 2, that handles business process workflow are “asynchronicity”, “transport independence”, “security” and “business centricity”. Asynchronicity guarantees that messages are dealt with upon receipt and responses are dispatched as soon as the information gathered for the response has been collected. Given encoded business rules and policies, the responses are automatically generated by the workflow engine 102. This includes the demand for, and receipt of, required information from the process control system (e.g., via communication links to the systems 104(1)-104(n)), a laboratory information system, a maintenance management system, etc. Transport independence ensures that alternate message channels may carry the data. It also insures that message sources and targets can be swapped out at any time to accommodate changes in the manufacturing business itself. Security is critical and inversely proportional to the number of human hands that touch the data along the message chain. Automated message processing using public key encryption (PKI) technologies can have a very positive affect on transaction security. Business-centricity implies the need to encode the business rules and policies that actually apply to any given step in a manufacturing process. Rules and policies encoded as XML rules and policy documents may be automatically interpreted by systems implementing the ‘Orchestration’. In addition to BizTalk, other integration technologies are available for potentially filling the gap between S95 defined Level 3 and Level 4 Enterprise Systems. For example, IBM offers integration technologies that leverage Java and Java Beans with J2EE.

Given that Web Services are based upon the open standard of HTTP transport and XML-encoded messaging, any operating system may be used to implement the message handlers at either end. Given an architecture that removes the bottlenecks inherent in human intervention, a manufacturing system based on S95 concepts could operate with real time response to business orders, delivering real time status reports, real time accounting and ultimately rapid delivery of the physical product.

Strategic Integration Considerations

Strategically, enterprise integration facilitated by the workflow engine 102 is based on well-accepted, industry-wide technologies and standards. A core issue is multi-vendor interoperability. Interoperability between vendors is a major concern for customers because of its impact on the cost and functionality of integrated solutions. The ability to utilize and leverage best-of-breed applications from several vendors allows customers to negotiate functionality in a competitive environment without sacrificing overall system functionality. Options and quality can increase dramatically. The products get better and costs decrease. Vendors compete based on product features, performance and quality, not compliance with the standard interface.

In the manufacturing industries, one of the best examples of multi-vendor interoperability is OPC-DA, which is the core interface standard for accessing process data from manufacturing control systems. It's a simple interface that was developed ten years ago and is now widely accepted. It provides access to 80-90% of the world's manufacturing process data. Just like the Internet, it's an interoperability standard. Subsequent OPC specifications have not reached the same high level of acceptance. As a further complication, the technology upon which OPC-DA was built is proprietary and dated.

One very important emerging concept is called Service Oriented Architecture (SOA). The industry definition of Service Oriented Architecture is still evolving, but can be described in general by the following: Service Oriented Architecture refers to a portfolio of loosely-coupled, network addressable business services. These services are programs that 1) communicate by exchanging well-understood messages and 2) are composed of a set of components which can be invoked and whose interface descriptions can be published and discovered. If the S95 model is to become the standard for manufacturing integration, then a set of standardized, interoperable S95 Services need to be defined and implemented on an industry-wide basis.

To date, a critical mass of interoperability standards have been agreed to by the big players in the industry, namely, Microsoft and IBM. These standards provide secure, robust communications based on interoperable Web Services. Creating a NET application that consumes a secure web service exposed by an IBM platform written in Java will not require a lot of work. Even though this level of standardization is very important, it still will not be sufficient for rich interoperability. Companies in any given domain will need to agree on the syntax and semantics of the services that will be exposed and consumed.

As an example, all major vendors in the manufacturing control and information domain are working together to define a set of SOA services that expose the rich, complex process information contained within manufacturing control and intelligent fieldbus systems. This effort is called OPC Unified Architecture (OPC-UA). If successful, it will become the industry standard SOA for manufacturing information and control systems integration of real time, historical and alarm/event data. The communication architecture at this level must be secure and highly robust. The OPC-UA Service definitions are being designed to provide for the following: build upon and improve the existing connectivity offered by the OPC Foundation's suite of specifications; leverage the installed base of OPC DA, HDA and A&E servers which provide access to 90% of the world's manufacturing systems process data; support the transport of process and manufacturing information from intelligent field devices up to ERP (Enterprise Resource Planning) systems including S95/B2MML; support security, robustness and fault tolerance; be based on SOA concepts and leverage Web Service technology and application development tools; efficiently transfer large amounts of data but flexible enough to transfer standard XML payloads; inherently handle complex data; and leverage as many existing industry standards as practical and viable.

At this level of information management within manufacturing, a large quantity of complex data must be transferred at high speed while maintaining high data quality, even under failure conditions. A strong argument can very quickly be made that these requirements are not limited to the control domain, but are becoming more important in the information and business domains as well. As manufacturing companies continue to strive for more automated and integrated manufacturing facilities, their reliance on plant information systems increases. The system disclosed in FIG. 1, meets such requirements through the use of robust high speed communications interfaces between the ERP system 100, the workflow engine 102 and the supervisory process control and manufacturing information systems 104(l)-104(n).

In an embodiment of the system described herein, a highly automated production environment exists where S95 Level 4 systems communicate directly with Level 3 and even Level 2 systems all the way down to modem intelligent field devices that contain highly structured data and are capable of very advanced behaviors. These production control systems maintain the robustness and integrity that is indigenous to modem Distributed Control Systems (DCS). OPC-UA brings to the table the SOA technology that enables this scenario by providing the vehicle for rich, secure, efficient and interoperable S95/B2MML Services within a manufacturing plant.

Better decision making through the timely delivery of quality information between business and automation systems, facilitated by the workflow engine 102, improves manufacturing production management. ISA S95 provides an excellent abstract model and basis for the disclosed integration, but does not specify specific implementation technology. On the other hand, B2MML provides S95 with a set of standard, concrete XML formats. Combining these standards with currently available software tools and communication technology facilitates creation of very flexible and robust S95-based solutions including the above-described workflow engine 102.

In view of the many possible embodiments to which the principles of the disclosed integrated business system and production management environment including an intermediate integration component may be applied, it should be recognized that the embodiments described herein with respect to the drawing figures are meant to be illustrative only and should not be taken as limiting the scope of invention. For example, those of skill in the art will recognize that some elements of the illustrated embodiments shown in software, stored on computer-readable media in the form of computer executable instructions, may be implemented in hardware and vice versa or that the illustrated embodiments can be modified in arrangement and detail without departing from the spirit of the invention. Therefore, the invention as described herein contemplates all such embodiments as may come within the scope of the following claims and equivalents thereof.

What is claimed is:

1. An integrated production management system comprising:
a business management system for providing a production request;
a production management system executing supervisory process control and manufacturing information applications providing high level control of production equipment and processes; and
a workflow engine, interposed between and communicatively coupled to the business management system and production management system, the workflow engine executing event-driven logic to carry out a negotiated production request, based upon the production request received from the business management system, through communications with the production management system, wherein the negotiated production request arises from closed loop negotiations carried out between the workflow engine and the business management system.

2. The integrated production management system of claim 1 wherein the business management system comprises an enterprise resource planning application.

3. The integrated production management system of claim 1 wherein the production management system comprises a supervisory process control and manufacturing information application.

4. The integrated production management system of claim 1 wherein the workflow engine resides on a network node separate from a network node including the business management system.

5. The integrated production management system of claim 1 wherein the closed loop negotiations are automated.

6. The integrated production management system of claim 1 wherein messages between the business management system and the workflow engine during closed loop negotiations are formatted according to an industry standard.

7. The integrated production management system of claim 6 wherein the industry standard is based upon an ISA standard.

8. The integrated production management system of claim 1 wherein messages between the business management system and the workflow engine during closed loop negotiations are formatted according to a schema.

9. The integrated production management system of claim 1 wherein the production request specifies a quantity.

10. The integrated production management system of claim 9 wherein the production request specifies a time.

11. The integrated production management system of claim 9 wherein the production request includes a quality specification.

12. A workflow engine for integrating management of production requests issued by business management systems and fulfilled by production management systems, the workflow engine including:
a business management system interface for receiving a production request from a business management system;
a production management system interface for communicating with a production management system; and
event-driven workflow logic to carry out a negotiated production request based upon the production request received from a business management system, through communications with the production management system, wherein the negotiated production request arises from closed loop negotiations carried out between the workflow engine and the business management system.

13. The workflow engine of claim 12 wherein the workflow engine resides on a network node separate from a network node including the business management system.

14. The workflow engine of claim 12 wherein messages between the business management system and the workflow engine during closed loop negotiations are formatted according to an industry standard.

15. The workflow engine of claim 12 wherein messages between the business management system and the workflow engine during closed loop negotiations are formatted according to a schema.

16. A method for coordinating operations, via networked communications, of a business management system and a production management system via an interposed event-driven workflow engine including logic for carrying out production requests received from the business management system through communications with the production management system, the method comprising:
receiving, by the workflow engine, a production request issued by a business management system;
generating a negotiated production request based upon the production request by the business management system, wherein the negotiated production request arises from closed loop negotiations carried out between the workflow engine and the business management system; and
communicating, by the workflow engine, with a production management system in accordance with event-driven workflow logic, to carry out the negotiated production request using production resources controlled by the production management system.

17. The method of claim 16 wherein the generating step comprises generating a production schedule based upon available production resources.

18. The method of claim 16 wherein the generating step comprises transmitting, by the workflow engine, a negative response to the production request based upon production resource availability.

19. The method of claim 16 further comprising the step of re-negotiating the negotiated production request in response to a changed condition.

20. The method of claim 19 wherein the changed condition involves a market condition.

21. The method of claim 19 wherein the changed condition involves a production condition.

22. A computer-readable medium including computer-executable instructions for coordinating operations, via networked communications, of a business management system and a production management system via an interposed event-driven workflow engine including logic for carrying out production requests received from the business management system through communications with the production management system, the computer-executable instructions facilitating performing the steps of:
receiving, by the workflow engine, a production request issued by a business management system;
generating a negotiated production request based upon the production request by the business management system, wherein the negotiated production request arises from closed loop negotiations carried out between the workflow engine and the business management system; and
communicating, by the workflow engine, with a production management system in accordance with event-driven workflow logic, to carry out the negotiated production request using production resources controlled by the production management system.
